(19) United States
(12) Patent Application Publication
(10) Pub. No.: US 2025/0117025 A1
(43) Pub. Date: Apr. 10, 2025

(54) SYSTEMS AND METHODS FOR ROBOT NAVIGATION

(71) Applicant: Honda Motor Co., Ltd., Tokyo (JP)

(72) Inventors: Viet anh LE, Ithaca, NY (US); Vaishnav TADIPARTHI, Ann Arbor, MI (US); Behdad CHALAKI, Ann Arbor, MI (US); Hossein NOURKHIZ MAHJOUB, Ann Arbor, MI (US); Jovin Jeevan D'SA, Ann Arbor, MI (US); Ehsan MORADI PARI, Ann Arbor, MI (US)

(21) Appl. No.: 18/907,188

(22) Filed: Oct. 4, 2024

Related U.S. Application Data
(60) Provisional application No. 63/588,372, filed on Oct. 6, 2023.

(51) Int. Cl. G05D 1/69; G05D 1/646; G05D 101/15

(52) U.S. Cl. CPC G05D 1/69; G05D 1/646; G05D 2101/15

(57) ABSTRACT

Systems and methods for controlling navigation of multiple robots are provided. The robots are configured to move within an environment in which pedestrians are also moving. Centralized and distributed game-theoretical approaches to control of the robots are described.

### CROSS-REFERENCE TO RELATED APPLICATIONS

This application claims the benefit of priority to U.S. Provisional Patent Application No. 63/588,372, filed Oct. 6, 2023, the entire contents of which are hereby incorporated by reference herein.

### BACKGROUND

Social crowd navigation for mobile robots among human pedestrians is a challenging task due to complex human-robot and human-human interactions, as well as the uncertainty and unpredictability of human behavior. Moreover, robots' behavior in crowd navigation is not only required to be safe, robust, and efficient like other robotic applications but also needs to ensure social compatibility in motion with human pedestrians.

### BRIEF DESCRIPTION

In one aspect, a computer-implemented method for controlling navigation of a plurality of mobile robots is provided. The method includes: (i) defining a potential game for the plurality of robots with input including a predicted trajectory of each of a plurality of humans in an environment in which the plurality of robots are configured to move and output including a potential function, (ii) iteratively executing processing of a two-player game algorithm until a pre-defined condition is satisfied, wherein, in the two-player game algorithm, the plurality of humans collectively represent a first player having a first cost function associated with the summed predicted trajectories of the plurality of humans, and the plurality of mobile robots collectively represent a second player having a second cost function including the potential function of the potential game, (iii) in response to the pre-defined condition being satisfied, generating control instructions for each robot of the plurality of robots based on output from the two-player game algorithm after a last iteration, and (iv) controlling each of the plurality of robots to move in accordance with the respective control instructions.

In another aspect, a computer-implemented method for controlling navigation of a plurality of mobile robots is provided. The method includes, by a controller, iteratively executing processing of a two-player game algorithm until a pre-defined condition is satisfied. The iteratively executing processing includes: (i) transmitting, by the controller to each of the plurality of robots, a predicted trajectory of each of a plurality of humans in an environment in which the plurality of mobile robots are configured to move, (ii) receiving, from each of the plurality of robots, a respective current best-response trajectory that is current to the respective iteration, (iii) transmitting, to each of the plurality of robots, the received current best-response trajectories of each other robot of the plurality of robots, and (iv) receiving, from each of the plurality of robots, a convergence signal in response to the transmitting. The method also includes, in response to the pre-defined condition being satisfied, generating, by the controller, control instructions for each robot of the plurality of robots based on output from the two-player game algorithm after a last iteration, and controlling each of the plurality of robots to move in accordance with the respective control instructions.

In yet another aspect, controllers and control systems programmed to implement the above-described methods are also provided.

### BRIEF DESCRIPTION OF THE DRAWINGS

FIG. 1 is a simplified view of an exemplary environment in which humans and robots are navigating.

FIG. 2 is a simplified schematic diagram of a robot navigation control system, in accordance with the present disclosure.

FIGS. 3A and 3B depict previous and predicted trajectories of humans and robots within the environment shown in FIG. 1.

FIG. 4 is a simplified view of robots navigating through the environment based on individual and shared objectives, representing a potential game.

FIGS. 5A and 5B depict a simplified view of the humans and robots navigating through the environment, representing a two-player game.

FIG. 6 is a flow diagram of a centralized robot navigation control process.

FIG. 7 is a flow diagram of a distributed robot navigation control process.

FIG. 8 is a flow diagram of a method of controlling navigation of a plurality of robots, in accordance with the present disclosure.

FIG. 9 is a flow diagram of another method of controlling navigation of a plurality of robots, in accordance with the present disclosure.

FIG. 10 is a schematic diagram of a computer device that may be used in the control system shown in FIG. 2.

### DETAILED DESCRIPTION

The present disclosure provides a control framework for the coordination of multiple robots as they navigate through crowded environments. More specifically, an interaction-aware control framework to coordinate robots among human pedestrians using game-theoretic model predictive control (MPC) and deep learning-based human trajectory prediction is provided. In at least some embodiments, a social long-short term memory (LSTM) model, which predicts the future trajectories of human pedestrians, is combined with an MPC formulation to derive the optimal control actions for the robots. It is recognized that this framework for the navigation and control of mobile robots is not restricted to the use of social LSTM models, and any other learning-based model/interactive model may be used for the prediction of human movement in the coupled prediction-and-planning methods described herein.

The goal of social multi-robot navigation is to navigate each robot from an initial position to their goals while interacting with the human pedestrians to avoid collisions and minimizing any discomfort during motion.

Game theory is an effective tool for formulating and analyzing different types of interactions among agents. In at least some exemplary embodiments, a potential game between the robots is combined with a two-player game between the robots and the humans. Centralized and distributed MPC algorithms based on an iterative best-response approach are provided.

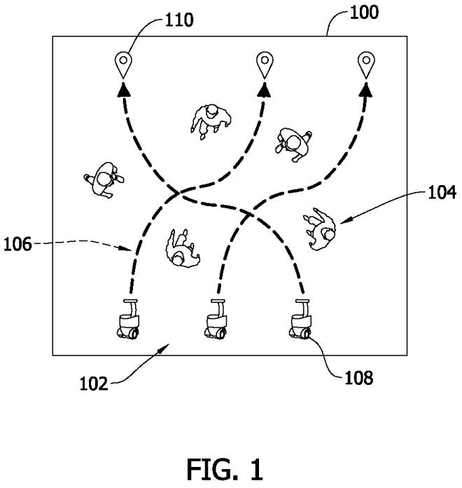

Turning now to the Figures, FIG. 1 is a simplified view of an exemplary environment 100 in which humans 104 and robots 102 are navigating. Paths 106, represented by dotted lines, represent potential trajectories of robots 102 from initial locations 108 to their respective goal locations 110. As is well understood, the movement of humans 104 (e.g., the trajectory, speed, etc.) is unpredictable, but can be approximately predicted, such as by using social Long-Short Term Memory (LSTM) algorithms, as described further herein. The systems and methods of the present disclosure are directed towards computing and executing control of robots 102 along paths 106 that account for and are responsive to the controlled trajectories of other robots 102 and predicted trajectories of humans 104. In the exemplary embodiment, as described herein below, the goal of navigating robots 102 within environment 100 is to navigate each robot 102 from a respective initial position 108 to a respective goal position 110, while interacting with humans 104 to avoid collisions and minimize human discomfort during motion thereof. In the exemplary embodiment, it is assumed that positions of humans 104 and robots 102 relative to a universal coordinate system are obtainable (e.g., via one or more positioning systems). In accordance with the present disclosure, game theory is applied to the environment 100 and the agents therein (robots 102 and humans 104) to compute an optimized motion of robots 102 and, subsequently, to control and navigate robots 102 according to the computed, optimized motion.

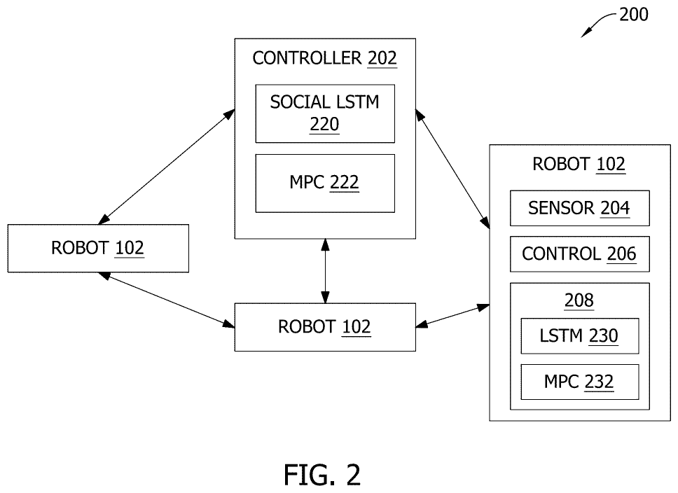

FIG. 2 is a simplified schematic diagram of a robot navigation control system 200. System 200 includes a controller 202 configured to execute various control algorithms, as described in greater detail herein. Controller 202 is communicatively coupled to a plurality of robots 102. For example, controller 202 is wirelessly connected to robots 102 over a wireless communication network (e.g., Wi-Fi, BLUETOOTH, NFC, 5G, 4G, etc.). In one embodiment, controller 202 includes various processing modules for executing respective functions. For example, controller 202 includes, but is not limited to including, a social LSTM module 220 and a model predictive control (MPC) module 222.

Each robot 102 includes one or more sensors 204, configured to collect sensor data related to the movement of the respective robot 102 and the environment around robot 102. In the exemplary embodiment, each robot 102 also includes one or more control components 206. Control components 206 include physical components of robots 102 that enable and execute movement of robots 102. Physical components 206 many include, but are not limited to including, wheels, belts, gears, rollers, motors, mechanical actuators, electrical actuators, electro-mechanical actuators, and the like.

Additionally, each robot 102 includes a computing assembly 208. Assembly 208 includes requisite processing, memory, and communication components enabling robot 102 to transmit and receive messages and data, to make local computations (including any computation described herein), to instruct control components 206, and the like. In some embodiments, assembly 208 includes a local social LSTM module 230, similar to social LSTM module 220 of controller 202, and a local MPC module 232, similar to MPC module 222 of controller 202. That is, where various computational functionality is herein described as being centrally performed at controller 202 using social LSTM module 220 or MPC module 222, such functionality may also be performed by one or more local social LSTM modules 230 or local MPC modules 232, respectively, at respective one or more robots 102. For example, in some embodiments, one robot 102 may compute navigation/control instructions for all robots 102 within an environment and then may transmit or broadcast the instructions to the other robots 102. As another example, each robot 102 is equipped with its own assembly 208 and communicates with other robots 102 through peer-to-peer communication or via controller 202. That is, it is contemplated that, in some embodiments, controller 202 may be omitted.

Although three robots 102 are depicted in the figures, it should be understood that the systems and methods of the present disclosure are applicable to groups of robots 102 of any number, including two robots as well as more than three robots.

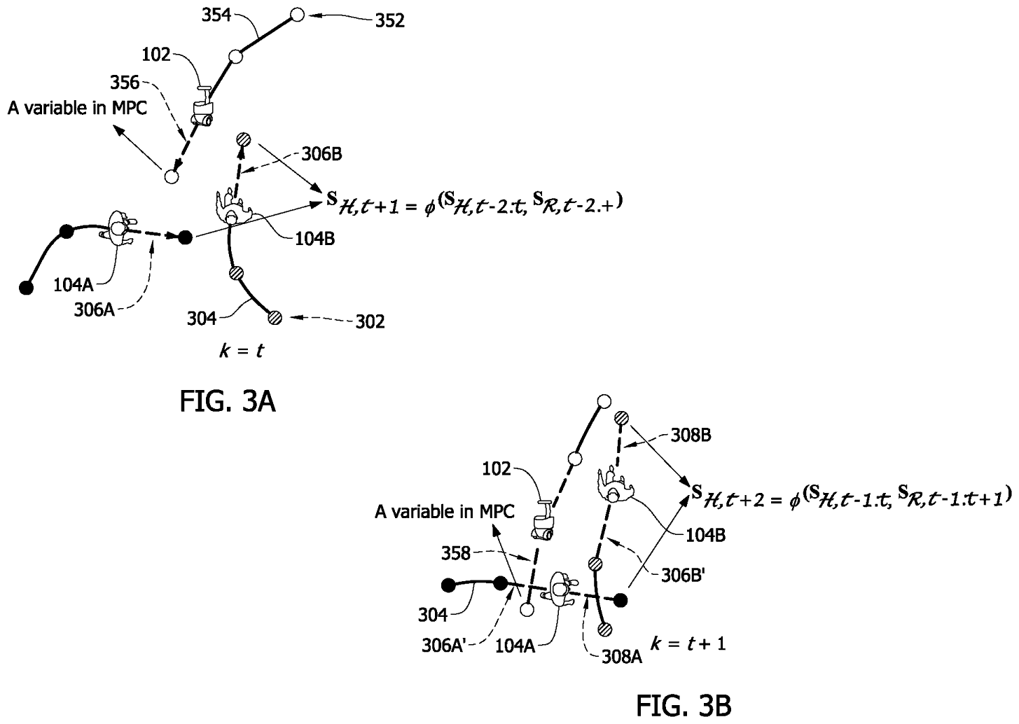

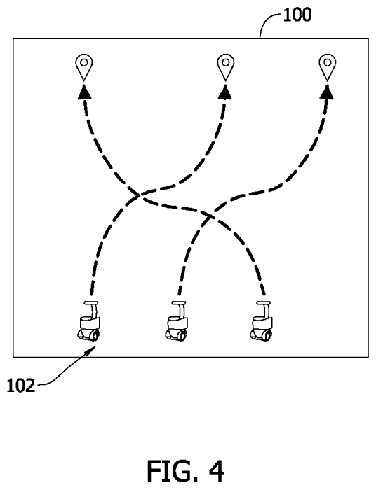

FIGS. 3A and 3B depict previous and predicted trajectories of agents within environment 100, including humans 104 and robots 102, across two time-steps within a coupled prediction-and-planning framework of robot navigation. As explained herein, the predicted trajectories of humans 104 are computed using a social LSTM model, and the controlled trajectories of robots 102 are computed using an MPC model (based in part on the outputs from the social LSTM model). For simplicity of discussion and illustration, only two humans 104 and one robot 102 within environment 100 are depicted in FIGS. 3A and 4B. Any processes described herein related to performance of social LSTM models or algorithms may be performed centrally, by controller 202, at social LSTM module 220. Additionally or alternatively, one or more of such processes may be performed in a distributed manner, by robot(s) 102, at respective local social LSTM modules 230 thereof. Likewise, any processes described herein related to performance of MPC models or algorithms may be performed centrally, by controller 202, at MPC module 222. Additionally or alternatively, one or more of such processes may be performed in a distributed manner, by robot(s) 102, at respective local MPC modules 232 thereof.

It should be understood that the use of this LSTM model for predicting human trajectories is for exemplary purpose. The present disclosure is not limited to these models nor even these classes of models. In alternative embodiments, human trajectories may be predicted by applying constant velocity, Kalman filters, intention-enhanced optimal reciprocal collision avoidance, social generative adversarial networks (GAN), social-NCE, sparse Gaussian processes, or other learning-based model(s).

In the exemplary embodiment, the social LSTM model is a recursive model configured to predict trajectories of pedestrians, such as humans 104, over a prediction period (also referred to as a prediction horizon) comprising a plurality of time steps, given observations of one or more previous actions of all humans 104 in the prediction set. The social LSTM model is applied to generate or compute simultaneous trajectory predictions for all pedestrians (humans 104) in the prediction set.

Specifically, the respective predicted motion of each human 104 for a single time step is computed, for each time step within the prediction horizon. At each time step within the prediction horizon, each human 104's predicted and actual positions in previous time steps are input to the social LSTM model. Notably, however, the motion of robots 102 is computed (e.g., using controller 202, as described further herein) at each time step and is therefore objectively known (e.g., predicted without error). In this way, the recursive, “single-step” social LSTM model enables coupled prediction and planning over the prediction/control horizon—that is, accounting for the mutual dependence between humans' and robots' future motion.

In FIG. 3A, the social LSTM model is applied to the motion of the two depicted humans 104, labelled here as human 104A and human 104B, for a first time step of the prediction horizon, beginning at time t. Each previous trajectory segment 304, representing previous motion of the respective human, is represented between two endpoints within an overall trajectory or path 302. These previous movements 304, which were actually conducted, are applied as input to the social LSTM model. An output from the social LSTM model is a predicted motion 306 for each respective human 104, represented as a dotted line segment extending from the respective human's current location to a predicted location or destination, across a single time step. For example, a predicted single time-step motion of human 104A is labelled 306A, and the predicted single time-step motion of human 104B is labelled as 306B.

FIG. 3B depicts the progression of the prediction horizon to a second time step beginning at time t+1. The existing trajectories 302 are again applied as input to the social LSTM model. Additionally, the predicted motions of the humans 104A, 104B from the first time step of the social LSTM model computations, labelled in FIG. 3B as 306A′ and 306B′, are incorporated into the processing for the prediction of the second time step. An output from the social LSTM model is a predicted motion 308 for each respective human 104, represented as a dotted line segment extending from the predicted destination resulting from the first time step predictions to a subsequent predicted location or destination. For example, the predicted single time-step motion, for the second time step, of human 104A is labelled 308A, and the predicted single time-step motion, for the second time step, of human 104B is labelled as 308B.

The MPC model for control of the motion of robots 102 (e.g., robot 102 depicted in FIGS. 3A and 3B) is implemented to compute the next time-step motion, based in part on the output from the social LSTM model, over a control period (also referred to as a control horizon) including one or more time steps. Moreover, the MPC model is employed for the motion of each robot as an individual as well as for the group of robots as a unit. Specifically, it is understood that each robot has an individual objective
to reach its respective goal location subject to various constraints—and a shared objective
relative motion of the group of robots. The computed motion for each robot 102 is an optimized solution to the MPC model considered for that specific robot 102, with inputs including the previous (actual) and the predicted (future) behavior of humans 104 (which itself is a variable that accounts for the mutual dependence between humans' and robots' motion), behavior of the other robots 102, constraints of the motion of that robot 102 (e.g., maximum speed, acceleration, etc.), and the individual objective for that robot 102.

Individual objectives and shared objectives, or any other constraints, may be weighted in different applications of the MPC model to prioritize different objectives. For example, in some formulations, the weight or significance of reaching the individual objective increases as the distance to the objective decreases. In some formulations, to prevent collision between a robot and any human pedestrian, the MPC model imposes a minimum threshold distance between the robot and any human. The minimum threshold distance is, in some embodiments, speed-dependent, such that the robot stays further away from any human as its speed increases (leading to less human discomfort).

Individual objectives include minimal distance to goal, minimal time to goal, minimal collisions, maximum human comfort, minimal human discomfort, minimal robot “jerk”, or minimal robot “freeze” or downtime (or any combination thereof). Shared objectives include “flocking” together or remaining within a threshold radius of one another, or maintaining another group-level formation than a flock, such as a particular shape or a minimum threshold distance between the robots.

In FIG. 3A, the MPC model is applied to the motion of robot 102, for a first time step of the control horizon, beginning at time t. Each previous trajectory segment 354, representing previous (actual) motion of robot 102, is represented between two endpoints within an overall trajectory or path 352. Inputs to the MPC model are described herein and include, in part, trajectories 302 and predicted motions 306 of humans 104 across the prediction/control horizon. An output from the MPC model is a controlled or computed motion 356 for robot 102, represented as a dotted line segment extending from the current location of robot 102 to a computed location or destination, across a single time step.

FIG. 3B depicts the progression of the control horizon to a second time step beginning at time t+1. The MPC model is again applied to the motion of robot 102, with inputs including the existing trajectories 302 and predicted motions 306, 308 of humans 104 (e.g., as predicted using the social LSTM model). An output from the MPC model is a computed motion 358 for robot 102, represented as a dotted line segment extending from the computed destination resulting from the first time step computations to a subsequent computed location or destination.

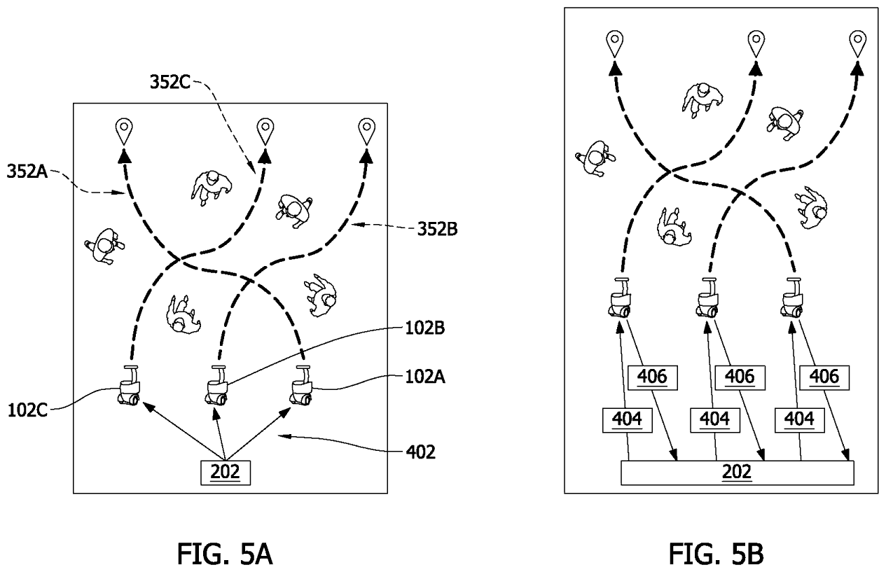

FIGS. 4, 5A, and 5B depict simplified schematic diagrams representing the application of game theory to control of the motion of robots 102 within environment 100. It should be understood that throughout the present disclosure, a “trajectory” may refer to a defined destination location (spaced from a current location or position), a movement having a defined heading, speed, and acceleration, or a combination thereof. Any trajectory may be defined or identified using objective coordinates (e.g., a Cartesian coordinate system) or relative coordinates.

In some embodiments, the game theory application takes a centralized MPC approach, in which controller 202 is programmed to centrally compute the solution to a centralized MPC function for each of robots 102, and generate control instructions for robots 102 based thereon.

In particular, the navigation of robots 102 relative to one another is characterized as a potential game with each robot 102 as a player (see FIG. 4). The potential function of the game at any time step within a control period (also referred to as a control horizon) is computed based on: (i) the sum of all robots' individual objectives (e.g., all actions available to each robot 102 at each time step over the control horizon, based on a position and computed trajectory of the respective robot 102 at each time step and a predicted trajectory of humans 104 over the control/prediction horizon), and (ii) the shared objective of all robots 102.

Taken with the potential game described above, the interaction between humans 104 and robots 102 is considered as a two-player game, with the group of humans 104 as one player and the group of robots 102 as the other player (see FIGS. 5A and 5B). Each player's strategy is defined by the trajectories of all players over the next control/prediction horizon (e.g., one or more time steps). The cost function for robots 102 is the potential function of the potential game, explained above. The cost function for humans 104 is computed relative to a deviation of motion from their predicted trajectory over each time step across the prediction horizon (e.g., as predicted using the social LSTM model). In other words, the predicted trajectory is assumed to be the best trajectory for humans 104.

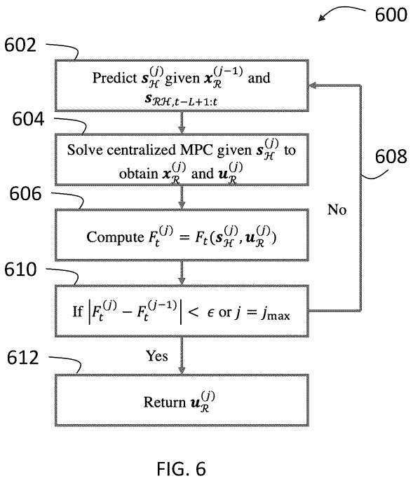

In the centralized MPC approach, given this two-player game, controller 202 performs an iterative, centralized computational process, including the following steps conducted at each time step within an overall control horizon. One embodiment of these steps, in accordance with one exemplary centralized MPC process 600, is shown in FIG. 6. Controller 202 computes (602) the predicted overall (or multi-step) trajectory for the humans 104 (e.g., using the social LSTM model) across a prediction horizon (which may correspond to the control horizon). Controller 202 optimizes (604) the centralized MPC function for each robot 102, obtaining or computing a proposed trajectory for each robot 102 across the control horizon. Controller 202 evaluates (606) the potential function based on the predicted human trajectories and the computed proposed robot trajectories.

Controller 202 iterates (608) these steps until a pre-defined condition is satisfied (610). That condition includes one of the following: the difference in the potential function at two consecutive iterations is less than a threshold value (which may be referred to as a “convergence condition”); or a maximum number of iterations is reached. Upon the condition being satisfied (610), controller 202 accepts the computed proposed trajectory of the last iteration, for each robot 102, as the computed best-response trajectory to be executed, for each robot 102. Controller 202 generates (612) control instructions 402 (see FIG. 5A) for each robot 102 based on the computed best-response trajectory, and transmits (612) control instructions 402 to each of robots 102 according to the final computation. Control instructions 402, when executed, cause each robot 102 to travel along a computed first section of the computed best-response trajectory, which may be referred to as a computed best-response single-step trajectory, in that it represents a single motion to be taken by the respective robot 102. These control instructions 402 thereby control robots 102A, 102B, 102C to travel, at each iteration, along a respective computed best-response (single-step) trajectory of a corresponding computed (overall) trajectory 352A, 352B, 352C. In some embodiments, this centralized MPC approach achieves Nash equilibrium or pseudo-Nash equilibrium.

In some embodiments, the game theory application takes a decentralized or distributed MPC approach, in which each robot 102 and controller 202 individually collaborate and exchange data to compute the solution to the individual MPC model for each respective robot 102. More specifically, each robot 102 locally solves its individual MPC model (e.g., using local MPC module 232), given the current best-response trajectories of other robots 102.

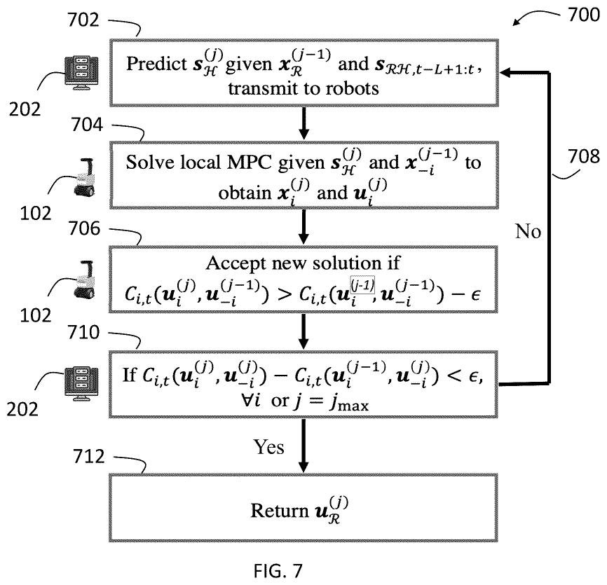

In the distributed MPC approach, given the above-presented two-player game, robots 102 and controller 202 together perform an iterative, distributed computational process, including the following steps conducted at each time step. One embodiment of these steps, in accordance with one exemplary distributed MPC process 700, is shown in FIG. 7.

Controller 202 computes (702) predicted trajectories 404 for humans 104 (e.g., using the social LSTM model) over a prediction horizon and transmits the predicted trajectories 404 to robots 102 (see also FIG. 5B). Where process 700 is being initiated, controller 202 also transmits an initial guess or estimation of a best-response trajectory for robots 102. Otherwise, controller 202 transmits (or has previously transmitted) the actual best-response trajectories previously computed by each robot 102 as actual, previous motions carried out by robots 102.

Each robot 102, in parallel, uses the predicted (human) trajectories (404) from controller 202 and the (estimated or actual) previous best-response trajectories of the other robots 102 as inputs to solve (704) the local MPC model. If the proposed solution—that is, a computed proposed trajectory—at that iteration improves the cost for the respective robot 102 relative to the cost of the collective previous best-response trajectory of all robots 1012, that robot 102 will accept (706) the computed proposed trajectory as the current best-response trajectory for itself. “Current,” in this context, refers to a current computation relative to an in-progress iteration. If not, the robot 102 accepts the previous best-response trajectory (or the initially estimated best-response trajectory, at initiation of process 700) as the current best-response trajectory for itself. Each robot 102 transmits its respective current best-response trajectory back to controller 202. Controller 202 may then distribute, to all robots 102, the current best-response trajectories received from all robots 102.

Each robot 102, in parallel, uses the received best-response trajectories from all robots 102, to again solve the local MPC model and determine whether the collective current best-response trajectory for all robots 102 improves the cost for the respective robot 102 relative to a previously computed best-response trajectory for all robots 102. If so, the robot 102 transmits a positive convergence signal to controller 202; if not, the robot 102 transmits a negative convergence signal to controller 202.

Controller 202 and robots 102 iterate (708) these steps until a pre-defined condition is satisfied (710). That condition includes one of the following: a positive convergence signal is received at controller 202 from all robots 102; or a maximum number of iterations is reached. Upon the condition being satisfied (710), controller 202 generates (712) control instructions (e.g., control instructions 402, as shown in FIG. 5A) for each robot 102, based on that robot's computed best-response trajectory. Controller 202 transmits (712) the control instructions to each of robots 102, thereby controlling robots 102A, 102B, 102C to travel, at each iteration, along a respective computed best-response (partial) trajectory of a corresponding (overall) trajectory 352A, 352B, 352C. In some embodiments, this distributed MPC process approaches pseudo-Nash equilibrium.

In some embodiments, it is contemplated that one robot 102 may function as a controller in the distributed MPC process. For example, controller 202 may be omitted, and the functions ascribed to controller 202 in the above description may be performed by a designated one of robots 102.

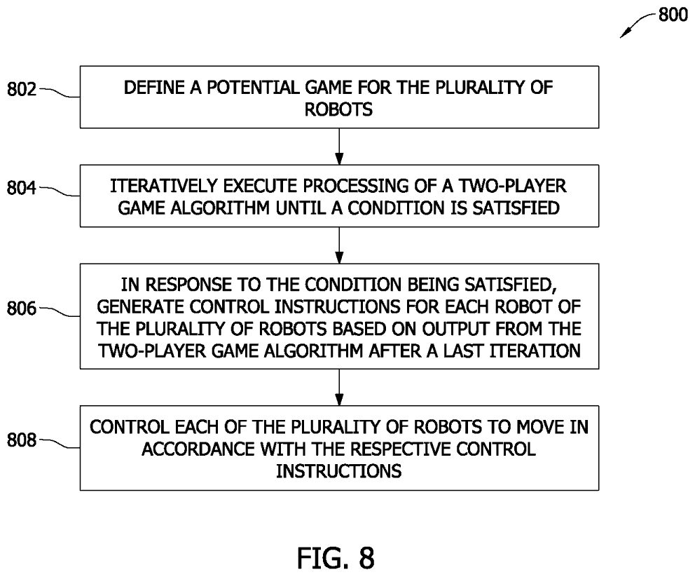

FIG. 8 is a flow chart of an exemplary method 800 for controlling navigation of a plurality of mobile robots, in accordance with the present disclosure. In the exemplary embodiment, method 800 may be a centralized MPC method, and includes defining 802 a potential game for the plurality of robots with input including a predicted trajectory of each of a plurality of humans in an environment in which the plurality of robots are configured to move and output including a potential function. Method 800 also includes iteratively executing processing 804 of a two-player game algorithm until a pre-defined condition is satisfied, wherein, in the two-player game algorithm, the plurality of humans collectively represent a first player having a first cost function associated with the summed predicted trajectories of the plurality of humans, and the plurality of mobile robots collectively represent a second player having a second cost function including the potential function of the potential game.

Method 800 further includes generating 806, in response to the condition being satisfied, control instructions for each robot of the plurality of robots based on output from the two-player game algorithm after a last iteration, and controlling 808 each of the plurality of robots to move in accordance with the respective control instructions.

Method 800 may include additional, fewer, or alternative steps, including those described elsewhere herein.

For example, in some embodiments, controlling 808 includes transmitting the control instructions, respectively, to each robot of the plurality of robots, the control instructions including computer-executable commands causing each robot to process and execute the respective commands.

In some embodiments, generating 806 includes generating control instructions defining a best-response trajectory for each respective robot. In some such embodiments, method 800 further includes computing, in the last iteration, a proposed trajectory of each of the plurality of mobile robots, and accepting the proposed trajectory as the best-response trajectory to be executed by each of the plurality of mobile robots.

In some embodiments, executing processing 804 includes optimizing a centralized MPC function for each of the plurality of robots to obtain a proposed trajectory for each of the plurality of robots, and evaluating the potential function using the proposed trajectory for each of the plurality of robots and the predicted trajectories of the plurality of humans.

In certain embodiments, the condition is satisfied when a difference in the output from the two-player game algorithm between a previous iteration and the last iteration is less than a threshold value. The condition may be a convergence condition. In some embodiments, the condition is satisfied when the last iteration corresponds to a maximum number of iterations.

In still further embodiments, method 800 includes computing the predicted trajectory of each of the plurality of humans by executing a social long-short term memory (LSTM) model.

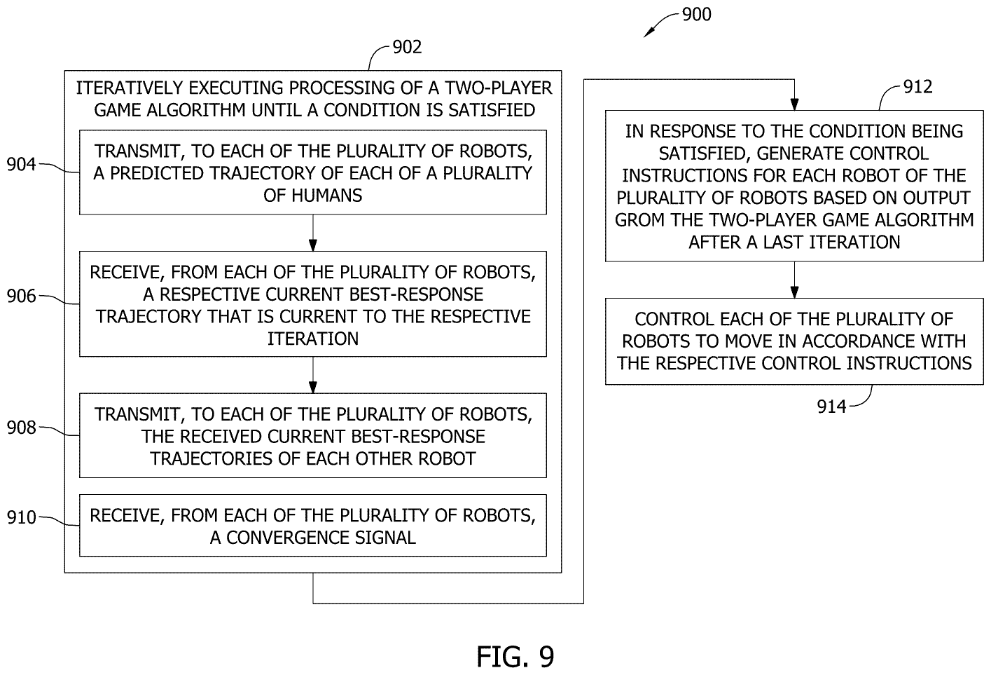

FIG. 9 is a flow chart of another exemplary method 900 for controlling navigation of a plurality of mobile robots, in accordance with the present disclosure. In the exemplary embodiment, method 900 may be a distributed MPC method, and includes, by a controller, iteratively executing processing 902 of a two-player game algorithm until a pre-defined condition is satisfied. The executing processing 902 includes transmitting 904, by the controller to each of the plurality of robots, a predicted trajectory of each of a plurality of humans in an environment in which the plurality of mobile robots are configured to move, and receiving 906, from each of the plurality of robots, a respective current best-response trajectory that is current to the respective iteration. The executing processing 902 also includes transmitting 908, to each of the plurality of robots, the received current best-response trajectories of each other robot of the plurality of robots, and receiving 910, from each of the plurality of robots, a convergence signal in response to transmitting 908.

Method 900 also includes generating 912, in response to the condition being satisfied, control instructions for each robot of the plurality of robots based on output from the two-player game algorithm after a last iteration, and controlling 914 each of the plurality of robots to move in accordance with the respective control instructions.

Method 900 may include additional, fewer, or alternative steps, including those described elsewhere herein.

For example, in some embodiments, controlling 914 includes transmitting, by the controller, the control instructions, respectively, to each robot of the plurality of robots, the control instructions including computer-executable commands causing each robot to process and execute the respective commands.

In some embodiments, generating 812 includes generating, by the controller, control instructions defining an actual best-response trajectory for each respective robot. In some such embodiments, method 900 further includes, in the last iteration, receiving, by the controller, a positive convergence signal from each of the plurality of mobile robots, and accepting the current best-response trajectories of the plurality of robots as the actual best-response trajectories.

In certain embodiments, the executing processing 902 includes solving, by each robot of the plurality of robots in parallel, a local MPC function to obtain the current best-response trajectory that is current to the respective iteration.

In further embodiments, the executing processing 902 includes in response to receiving the current best-response trajectories of each other robot of the plurality of robots, solving, by each robot, a local MPC function to determine whether the current best-response trajectories of the plurality of robots improves an outcome relative to previously computed best-response trajectories of the plurality of robots. In some such embodiments, method 900 also includes, when the solving indicates an improved outcome, transmitting, by each of the plurality of robots, the convergence signal including a positive convergence signal to the controller.

In some embodiments, the condition is satisfied when the convergence signal includes a positive convergence signal. In some embodiments, the condition is satisfied when the last iteration corresponds to a maximum number of iterations.

In certain embodiment, method 900 further includes computing the predicted trajectory of each of the plurality of humans by executing a social long-short term memory (LSTM) model.

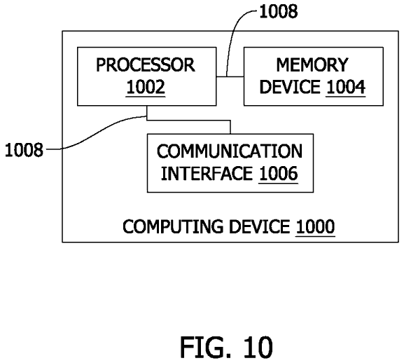

FIG. 10 is a block diagram of an example computing device 1000. Computing device 1000, which may be similar to controller 202 (see FIG. 2), robot(s) 102 (see FIG. 1), and/or assembly 208 of robot(s) 102 (see FIG. 2), includes a processor 1002 and a memory device 1004. Processor 1002 is coupled to memory device 1004 via a system bus 1008. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, memory device 1004 includes one or more devices that enable information, such as executable instructions or other data (e.g., sensor data), to be stored and retrieved. Moreover, memory device 1004 includes one or more computer readable media, such as, without limitation, dynamic random access memory (DRAM), static random access memory (SRAM), a solid state disk, or a hard disk. In the example embodiment, the memory device 604 stores, without limitation, application source code, application object code, configuration data, additional input events, application states, assertion statements, validation results, or any other type of data. The computing device 1000, in the example embodiment, may also include a communication interface 1006 that is coupled to processor 1002 via system bus 1008.

In the example embodiment, processor 1002 may be programmed by encoding an operation using one or more executable instructions and providing the executable instructions in memory device 1004. In the example embodiment, processor 1002 is programmed perform functions such as those described herein with respect to FIGS. 6-9.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

The present disclosure is directed to a game-theoretical approach to controlling navigation of multiple robots within an environment, accounting for robot objectives and human objectives (or preferences). As described herein, each game theory model or algorithm applies (i) a potential game algorithm relative to each robot, and (ii) a two-player game algorithm accounting for robots and humans (as groups). These algorithms utilize input data regarding the position of humans and robots at each time step within an overall prediction horizon or control horizon (which may include a plurality of time steps). The above description and below examples provide exemplary models to generate positional input data for humans and robots-namely, a single-step social LSTM model and an MPC model, respectively. Exemplary single-step LSTM models and MPC models are provided below. However, it should be understood that any exemplary models, algorithms, formulae, and equations presented herein should be taken as illustrative; other models, algorithms, formulae, and equations may be applied.

As is recognized, social crowd navigation for mobile robots among human pedestrians remains a challenging task due to complex human-robot and human-human interactions, as well as the uncertainty and unpredictability of human behavior. Moreover, robots' behavior in crowd navigation is not only required to be safe, robust, and efficient like other robotic applications but also needs to ensure social compatibility in motion with human pedestrians. This is why social crowd navigation has attracted considerable attention in recent years.

There have been several applications where a team of autonomous systems must operate while interacting with humans, such as connected and automated driving in mixed traffic, robotic assistance devices, etc. Multi-robot navigation in crowds is a typical application of cyber-physical-human systems that is significantly more challenging than single robots, as it involves multi-agent coordination and control for human-robot interaction.

The navigation problem for robots in crowds can be approached through two main strategies: decoupled prediction and planning and coupled prediction and planning. In the decoupled approach, human agents are considered dynamic obstacles and, thus, mobility-based interactions are ignored. As a result, “freezing robot problem” and “reciprocal dance problem” can occur and cause discomfort to pedestrians nearby. In contrast, mutual interactions between human and robot agents are embedded in the coupled approach, by appropriately incorporating human motion prediction into the problem of robot navigation. This approach has been observed to somewhat mitigate the freezing robot and reciprocal dance problems, thereby making it a recent trend in crowd navigation research.

Several recent studies in crowd navigation have developed reinforcement learning (RL) methods, in which a control policy for a robot is approximated by deep neural networks, such as collision avoidance deep RL (CADRL), long short-term memory (LSTM)-RL, socially aware RL (SARL), as well as graph-based techniques. However, the efficacy of RL policies is often degraded if the robot encounters new scenarios that are different from the training scenario.

On the other hand, optimization-based approaches such as model predictive control (MPC) do not depend on offline training and can generalize well with appropriate parameter tuning. In MPC, the trajectories of robots over a finite control horizon are optimized, given certain prediction models of human trajectories. Various human prediction models have been used together with MPC in the literature, such as constant velocity, Kalman filters, intention-enhanced optimal reciprocal collision avoidance, social generative adversarial networks (GAN), and LSTM. Due to the complexity of human behavior, recent data-driven methods such as Social-LSTM, Social-GAN, Social-NCE, or sparse Gaussian processes have demonstrated more accurate trajectory prediction compared to domain knowledge-based models. Thus, combining machine learning techniques with MPC has the potential to enhance the efficacy of overall navigation.

While there are increasing studies on social navigation for an individual robot in crowds, the problem of multi-robot cooperative navigation among human pedestrians has not been fully explored. Other work has focused on multi-robot collision avoidance while the humans were modeled as dynamic obstacles with constant velocities; in this work, therefore, the human-robot interaction was not considered.

The present disclosure proposes an interaction-aware control framework to coordinate robots among human pedestrians using game-theoretic MPC and deep learning-based human trajectory prediction. First, an MPC problem is formulated to find the optimal control actions for the robots in a receding horizon fashion, and Social-LSTM, a state-of-the-art trajectory prediction model, is integrated into the MPC formulation. To solve the resulting problem, the concept of the potential game for multi-robot coordination is utilized, combined with a two-player game for human-robot interaction to develop two algorithms for centralized and distributed MPC. The effectiveness of the proposed framework is demonstrated with simulations of a crowd navigation scenario, in which the robots exhibit coordinated flocking behavior while simultaneously navigating toward their respective goals.

### Problem Statement

The disclosure considers an environment [symbol] ⊂ [symbol] ² with agents including M∈ [symbol] robots and N−M human pedestrians, illustrated in FIG. 1. We denote [symbol] ={1, . . . , M}, [symbol] ={N−M+1, . . . , N}, and [symbol] = [symbol] ∪ [symbol] the sets of robots, pedestrians, and all agents respectively.

At time step k∈ [symbol] , let s_{i,k}=[s_{i,k}^{x}, s_{i,k}^{y}]^{T}∈ [symbol] , v_{i,k}=[v_{i,k}^{x}, v_{i,k}^{y}]^{T}∈ [symbol] ², and a_{i,k}=[a_{i,k}^{x}, a_{i,k}^{y}]^{T}∈ [symbol] ² be the vectors corresponding to position, velocity, and acceleration of the robot i∈ [symbol] in Cartesian coordinates, respectively, where each vector consists of two components for x- and y-axis. Let x_{i,k}=[s_{i,k}^{T}, v_{i,k}^{T}]^{T} and u_{i,k}=a_{i,k} be the vectors of states and control actions for the robot i at time step k, respectively, while s_{j,k}∈ [symbol] denotes the position of pedestrian j∈ [symbol] at time step k. For simplicity in notation, we use X_{i,t}_{₁}_{:t}_{₂} for agent i∈ [symbol] to denote the concatenated arbitrary vector X from time step t₁ to time step t₂. We denote the state and action spaces for robot i as [symbol] ᵢ and [symbol] ᵢ, i.e., x_{i,k}∈ [symbol] ᵢ and u_{i,k}∈ [symbol] ᵢ, respectively.

Assumption 1. We assume that [symbol] ᵢ and [symbol] ᵢ are nonempty, compact, and connected sets for all i∈ [symbol] .

The goal of social multi-robot navigation is to navigate each robot i from the initial position sᵢ^{init}∈ [symbol] to their goals sᵢ^{goal}∈ [symbol] while interacting with the human pedestrians to avoid collisions and minimizing any discomfort during motion. Consider the following assumption to facilitate positioning and communication between the robots for coordination.

Assumption 2. The robots' and pedestrians' real-time positions can be obtained by a positioning system and stored by a central coordinator (e.g., a computer). The robots and the coordinator can exchange information through wireless communication.

Model Predictive Control (MPC) with Social-LSTM

The proposed framework of the present disclosure combines a Social-LSTM model, which predicts the future trajectories of human pedestrians with an MPC formulation to derive the optimal control actions for the robots. Next, the Social-LSTM model and MPC formulation are formalized.

### A. Human Motion Prediction Using Social-LSTM

Let t∈ [symbol] be the current time step, H∈ [symbol] ⁺ be the control/prediction horizon length, and [symbol] ₜ={t, t+1, . . . , t+H=1} be the set of time steps in the next control horizon. The human prediction model aim at predicting the trajectories of pedestrians over a prediction horizon of length H given the observations over L∈ [symbol] ⁺ previous time steps of all agents' trajectories. Social-LSTM was developed for jointly predicting the multi-step trajectory of multiple agents. This disclosure considers recursive prediction for the pedestrians' positions using the single-step Social-LSTM model denoted by ϕ(⋅): [symbol] → [symbol] as follows:

$${s}_{ℋ , k + 1} = ϕ ( {s}_{ℛℋ , k - L + 1 : k} ) , \qquad ( EQ . 1 )$$

$$∀ k ∈ {ℐ}_{t} .$$

The prediction model of the present disclosure (EQ. 1) differs from at least one known Social-LSTM model. First, the known Social-LSTM model performs simultaneous prediction for all N agents, i.e., both robots and humans. However, in the present disclosure, the positions of human pedestrians are precisely extracted from the joint predictions. Additionally, the Social-LSTM model is considered with single-step prediction, where predictions are made recursively throughout the control horizon at each time step instead of a multi-step prediction for the entire control horizon. The recursive technique yields a coupled prediction and planning approach, while using the multi-step prediction model leads to a decoupled prediction and planning approach that ignores the mutual dependence between humans' and robots' future behavior. Further, at each time step of the control horizon, the humans' predicted positions in previous time steps are used as the inputs of the Social-LSTM model, while the predicted positions of the robots are discarded, because the future robots' positions depend on the solution of the MPC problem.

Remark 1. Though social-LSTM is utilized at the human motion prediction model, other deep learning models can be used alternatively.

### B. Model Predictive Control Formulation

Henceforth, for ease of notation, we omit the time subscript of the variables if it refers to all time steps within the control horizon. For example, we use uᵢ, xᵢ, and sⱼ, ∀i∈ [symbol] , j∈ [symbol] , instead of u_{i,t:t+H-1}, x_{i,t+1:t+H}, and s_{j,t+1:t+H}. It is also considered that the dynamics of each robot are governed by a discrete-time double-integrator model:

$${s}_{i , k + 1} = {s}_{i , k} + τ {υ}_{i , k} + \frac{1}{2} {τ}^{2} {a}_{i , k} , \qquad ( EQ . 2 )$$

$${υ}_{i , k + 1} = {υ}_{i , k} + τ {a}_{i , k} ,$$

where τ∈ [symbol] ⁺ is the sampling time period. Each robot has an individual objective Jᵢ(uᵢ, xᵢ, [symbol] ) and a shared objective with other robots J₋₁(xᵢ, x₋ᵢ), where we define x₋₁^{T}=[xⱼ^{T} [symbol] as the concatenation of the state vectors of all other robots in the set [symbol] . We consider pairwise objective between robots

$${J}_{- i} ( {x}_{i} , {x}_{- i} ) = {\sum }_{j ∈ ℛ \backslash \{ i \}} {J}_{ij} ( {x}_{i} , {x}_{j} ) . \qquad ( EQ . 3 )$$

We formulate the local MPC problem for robot i at time t:

$$\text{?} {J}_{i} ( {u}_{i} , {x}_{i} , {s}_{ℋ} ) + {\sum }_{j ∈ ℛ \backslash \{ i \}} {J}_{ij} ( {x}_{i} , {x}_{j} ) , \qquad ( EQ . 4 )$$

$$subject to : ( 1 ) , ( 2 ) , {u}_{i , k} ∈ {𝒰}_{i} , {x}_{i , k + 1} ∈ {𝒳}_{i} , ∀ k ∈ {ℐ}_{t} ,$$

$$given : {s}_{ℛℋ , t - L + 1 : t} , {x}_{i , t} .$$

$$\text{?} \text{indicates text missing or illegible when filed}$$

Note that any constraints, e.g., collision avoidance constraints, can be included in the objective function by penalty functions with sufficiently large weights.

Assumption 3. We assume that the individual objective Jᵢ and shared objective Jᵢⱼ, for all i, j∈ [symbol] , are continuous and differentiable functions everywhere over [symbol] and [symbol] .

### Multi-Robot Cooperative Navigation

In this section, the MPC formulation (EQ. 4) is illustrated by considering the scenario illustrated in FIG. 1, where multiple robots navigate to their goals among several human pedestrians. The robots need to reach their goals and avoid collision with human pedestrians and other robots. Moreover, since the robots move in the same direction, they can coordinate for moving in a flock while navigating to the goals. It is assumed that the states and control inputs of robots i∈ [symbol] are subject to the following bound constraints:

$$- {υ}_{max} \leq {υ}_{i , k}^{x} , {υ}_{i , k}^{y} \leq {υ}_{max} , \qquad ( EQ . 5 )$$

$$- {a}_{max} \leq {a}_{i , k}^{x} , {a}_{i , k}^{y} \leq {a}_{max} ,$$

where vₘₐₓ∈ [symbol] ⁺ and aₘₐₓ∈ [symbol] ⁺ are the maximum speed and acceleration of the robots, respectively.

We formulate individual and shared objectives by weighted sums of several features. For robot i, we consider a tracking minimization to a desired reference trajectory

$${J}_{i}^{goal} ( {s}_{i} ) = \frac{{\sum }_{k = t}^{t + H - 1} {( {s}_{i , k + 1} - {s}_{i , k + 1}^{ref} )}^{⊤} ( {s}_{i , k + 1} - {s}_{i , k + 1}^{ref} )}{{‖ {s}_{i , t} - {s}_{i}^{goal} ‖}_{2} + δ} \qquad ( EQ . 6 )$$

where s_{i,k+1}^{ref} is the desired position at time k+1. The feature is normalized by the distance to the goal where δ∈ [symbol] ⁺ is a small positive number. Consequently, the significance of the goal-reaching objective increases as the robot approaches its intended destination. We compute the desired reference trajectory for robot i based on a straight line to its goal

$${s}_{i , k + 1}^{ref} = {s}_{i , k}^{ref} + min \{ τ {υ}_{max} , ‖ {s}_{i}^{goal} - {s}_{i , k}^{ref} ‖ \} \frac{{s}_{i}^{goal} - {s}_{i , t}^{ref}}{‖ {s}_{i}^{goal} - {s}_{i , t}^{ref} ‖} , \qquad ( EQ . 7 )$$

for k∈ [symbol] ₜ and s_{0,t}^{ref}=s_{0,t}. In addition, we minimize acceleration and jerk of the robot's motion by:

$${J}_{i}^{acce} ( {u}_{i} ) = {\sum }_{k = t}^{t + H - 1} {u}_{i , k}^{⊤} {u}_{i , k} , \qquad ( EQ . 8 )$$

$$\text{?} ( {u}_{i} ) = {\sum }_{k = t}^{t + H - 1} {( {u}_{i , k} - {u}_{i , k - 1} )}^{⊤} ( {u}_{i , k} - {u}_{i , k - 1} ) . \qquad ( EQ . 9 )$$

$$\text{?} \text{indicates text missing or illegible when filed}$$

To prevent collision between a robot and any human pedestrian, we impose the following constraint that the distance between the robot and each pedestrian is greater than a safe speed-dependent distance

$${{{g}_{ij} ( {x}_{i , k + 1} , {s}_{j , k + 1} ) = {d}_{min}^{2} + ρ ‖ {υ}_{i , k + 1} ‖}_{2}^{2} - ‖ {s}_{i , k + 1} - {s}_{j , k + 1} ‖}_{2}^{2} \leq 0 , \qquad ( EQ . 10 )$$

∀i∈ [symbol] , j∈ [symbol] , where dₘᵢₙ∈ [symbol] ⁺ is a minimum allowed distance ρ∈ [symbol] ⁺ is a scaling factor. A speed-dependent term is included in the above constrain to ensure that the robot stays farther away from the humans while moving at high speed, leading to less human discomfort. Similarly, we consider an inter-robot collision avoidance constraint

$${{g}_{ij} ( {x}_{i , k + 1} , {s}_{j , k + 1} ) = {d}_{min}^{2} - ‖ {s}_{i , k + 1} - {s}_{j , k + 1} ‖}_{2}^{2} \leq 0 , \qquad ( EQ . 11 )$$

∀i, j∈ [symbol] . The omission of a speed-dependent term in EQ. 11 is justified by the desire to maintain consistent with the subsequent shared objective, encouraging robots to move towards their goal while staying close to one another.

We incorporate the collision avoidance constraint into the objective function as a soft constraint by using a smooth max penalty function as follows:

$$\text{?} ( {x}_{i} , {x}_{j} ) = {\sum }_{k = t}^{t + H - 1} s max ( {g}_{ij} ( {x}_{i , k + 1} , {x}_{j , k + 1} ) ) . \qquad ( EQ . 12 )$$

$$\text{?} \text{indicates text missing or illegible when filed}$$

The smoothed max penalty function is defined as

$$s max ( z ) = \frac{1}{μ} log ( exp ( μ z ) + 1 ) ,$$

where μ∈ [symbol] ⁺ is a parameter that adjusts the smoothness of the penalty function. Additionally, the shared objective between robots i and j includes the following flocking control objective:

$$\text{?} ( {x}_{i} , {x}_{j} ) = {\sum }_{k = t}^{t + H - 1} {( {‖ {s}_{i , k + 1} - {s}_{j , k + 1} ‖}_{2} - {d}_{ij} )}^{2} , \qquad ( EQ . 13 )$$

$$\text{?} \text{indicates text missing or illegible when filed}$$

where dᵢⱼ∈ [symbol] ⁺ is the desired distance between two robots while moving in a flock. For everywhere differentiability, we approximate the L₂-norm by ∥z∥₂≈\sqrt{z^{T}z+δ}, where δ∈ [symbol] ⁺ is a small positive number.

Hence, the individual objective can be given by:

$$( EQ . 14 )$$

$${J}_{i} ( {u}_{i} , {x}_{i} , {s}_{ℋ} ) = {ω}_{i}^{goal} {J}_{i}^{goal} ( {x}_{i} ) + {ω}_{i}^{acce} {J}_{i}^{acce} ( {u}_{i} ) + \text{?} ( {u}_{i} ) + {\sum }_{j ∈ ℋ} \text{?} ( {x}_{i} , {s}_{j} ) ,$$

$$\text{?} \text{indicates text missing or illegible when filed}$$

and the shared objective is given as follows:

$${J}_{ij} ( {x}_{i} , {x}_{j} ) = \text{?} ( {x}_{i} , {x}_{j} ) + \text{?} ( {x}_{i} , {x}_{j} ) . \qquad ( EQ . 15 )$$

$$\text{?} \text{indicates text missing or illegible when filed}$$

Centralized Vs. Distributed Model Predictive Control

The following examples illustrate exemplary approaches to applying game theory to the control of navigation of multiple robots within an environment including human pedestrians.

### Centralized Model Predictive Control (CMPC)

1. Multi-Robot Coordination as a Potential Game: Given the MPC Problem (EQ. 4) for each robot, we define a game for multi-robot navigation as follows.

Definition 1. At each time step t for control/prediction horizon length [symbol] ₜ, we define an M-player game for multi-robot navigation as [symbol] :={ [symbol] , {C_{i,t} [symbol] }, where [symbol] = [symbol] ₁^{H}× [symbol] ₂^{H}× . . . × [symbol] _{M}^{H} while [symbol] ᵢ^{H} is the set of all action sequences of robot i in [symbol] ₜ over a horizon H (also referred to as a strategy set). Let uᵢ∈ [symbol] ᵢ^{H} be a valid strategy set for robot i and a joint strategy adopted by other players be denoted by u₋ᵢ:=[uⱼ^{T} [symbol] ∈ [symbol] ₋₁^{H}. Then, the cumulative cost for each robot i over [symbol] ₜ is denoted by C_{i,t}(uᵢ, u₋ᵢ):=Jᵢ(⋅)+J₋ᵢ(⋅), which can be evaluated by the objective function in EQ. 4.

The following definition of a continuous exact potential game has been presented.

Definition 2. If for every robot i∈ [symbol] , uᵢ is a nonempty, compact, and connected set (extending Assumption 1), C_{i,t}(⋅) is a continuous and differentiable function (Assumption 3), then the game [symbol] is a continuous exact potential game if and only if there exists a function Ft: [symbol] → [symbol] that is continuous and differentiable on [symbol] and satisfies

$$\frac{\partial {C}_{i , t} ( {u}_{i} , {u}_{- i} )}{\partial {u}_{i}} = \frac{\partial {F}_{t} ( {u}_{i} , {u}_{- i} )}{\partial {u}_{i}} , \qquad ( EQ . 16 )$$

$$∀ {u}_{i} ∈ {𝒰}_{i}^{H} ,$$

$${u}_{- i} ∈ {𝒰}_{- i}^{H} ,$$

where [symbol] ᵢ^{H} and [symbol] ₋ᵢ^{H} are the strategy sets as defined previously. The function Fₜ is called a potential function of the game.

Remark 2. The conditions in Definition 1 hold for multi-robot cooperative navigation presented in Section IV as given in EQ. 5, the domains [symbol] ᵢ and [symbol] ᵢ are nonempty, compact, and connected, while the individual and shared objective functions shown in EQ. 14 and EQ. 15 are everywhere continuous and differentiable.

Lemma 1. [symbol] is a continuous exact potential game if Jᵢⱼ(xᵢ, xⱼ)=Jⱼᵢ(xⱼ, xᵢ) and the potential function at time step t is computed by:

$$\text{?} ( {u}_{ℛ} , {s}_{ℋ} ) = {\sum }_{i ∈ ℛ} {J}_{i} ( {u}_{i} , {x}_{i} , {s}_{ℋ} ) + {\sum }_{i , j ∈ ℛ , i \neq j} {J}_{ij} ( {x}_{i} , {x}_{j} ) , \qquad ( EQ . 17 )$$

$$\text{?} \text{indicates text missing or illegible when filed}$$

where given the system dynamics of EQ. 2, the right-hand side of EQ. 17 can be expressed as a function of the joint strategy [symbol] and the pedestrians' predicted trajectory [symbol] in the left-hand side.

In order to satisfy Lemma 1 for the scenario presented in Section IV, we choose ωᵢⱼ^{coll}=ωᵢⱼ^{coll} and ωᵢⱼ^{floc}=ωⱼᵢ^{floc}, ∀i, j∈ [symbol] , i≠j.

2. Human-Robot Interaction as a Two-Player Game: Because a Nash equilibrium can be found by optimizing the potential function of the game at each time step, the multi-robot navigation algorithm can be implemented in a centralized manner (using only a central coordinator) by solving the centralized MPC problem:

$${minimize}_{{u}_{ℛ}} \text{?} ( {u}_{ℛ} , {s}_{ℋ} ) , \qquad ( EQ . 18 )$$

$$subject to : ( 1 ) , ( 2 ) , {u}_{ℛ} ∈ {𝕌}_{ℛ} , {x}_{i , k + 1} ∈ {𝒳}_{i} ,$$

$$given : \text{?} , \text{?} ,$$

$$\text{?} \text{indicates text missing or illegible when filed}$$

where the constraints hold for all i∈ [symbol] and k∈ [symbol] ₜ. Due to the complexity of the Social-LSTM network, solving the MPC problem in EQ. 18 would be computationally intractable. Therefore, iterative best response (IBR), a commonly used algorithm in game theory, is used to find a Nash equilibrium. A two-player game is first defined for human-robot interaction.

Definition 3. At each time step t, we define a two-player game for human-robot interaction as [symbol] :={{ [symbol] , [symbol] }, { [symbol] , [symbol] }, {Fₜ( [symbol] , [symbol] ), Iₜ( [symbol] , [symbol] )}, where

$${I}_{t} ( {s}_{ℛ} , {s}_{ℋ} ) = \text{?} {‖ {s}_{ℋ , k + 1} - ϕ ( {s}_{ℛℋ , k - L + 1 : k} ) ‖}_{2} . \qquad ( EQ . 19 )$$

$$\text{?} \text{indicates text missing or illegible when filed}$$

In this game, the group of robots and the group of humans are considered two players; each player's strategy is defined by the trajectories over the next control horizon. The cost function for robots is the objective function in EQ. 18, while the cost function for human pedestrians is computed by the deviation to the predicted trajectories given by EQ. 1. In other words, it is assumed that the best strategy for human pedestrians is to follow the trajectories given by the output of the Social-LSTM model (EQ. 1). The prediction model is expected to encode the fundamentals of pedestrian motion, such as collision avoidance, path following, and comfort.

In the IBR approach, a single agent updates its strategy at each iteration based on its best response to the others' strategies. Therefore, given the human-robot interaction game (Definition3), EQ. 18 can be solved by sequentially computing the Social-LSTM prediction and optimizing the MPC objective function. All the steps may be performed by the coordinator until the difference in the potential function evaluated at two consecutive iterations is smaller than a threshold ξ∈ [symbol] ⁺, or a maximum number of iterations jₘₐₓ∈ [symbol] is reached. The details are provided in Algorithm 1. If the algorithm converges, the converged point is a Nash equilibrium. However, it does not always converge; it may even cycle between strategies.

Algorithm 1 IBR-based centralized MPC

Require: t, H, jₘₐₓ, ξ, [symbol] , [symbol] , [symbol] , t−L+1 [symbol] .

| | |
|---|---|
| 1: | for j = 1, 2, . . . , jₘₐₓ do |
| 2: | Predict [symbol] using (1) given [symbol] and [symbol] , t − L+1 [symbol] . |
| 3: | Solve (18) given [symbol] to obtain [symbol] and [symbol] . |
| 4: | Compute Fₜ^{(j)} = Fₜ ( [symbol] , [symbol] ). |
| 5: | if \|Fₜ^{(j)} − Fₜ^{(j-1)} \| ≤ ξ then |
| 6: | return [symbol] |
| 7 | end if |
| 8: | end for |
| 9: | return [symbol] |

[symbol]

indicates data missing or illegible when filed

### B. Distributed MPC (DMPC)

The present disclosure also provides an IBR-based distributed MPC algorithm in which the coordinator and the robots collaborate and communicate to solve the problem. Each robot repeatedly solves its local MPC problem (EQ. 4) given the current best-response trajectories of other robots in parallel. It is contemplated that a distributed technique may make the system less vulnerable to any single point of failure, and may decrease the computational overhead for the coordinator. The robots' current best-response trajectories can be exchanged with the other robots through communication between the coordinator and the robots. Though the IBR approach advances towards a Nash equilibrium in a continuous exact potential game, convergence may not be achieved within a finite number of iterations. Hence, to improve the convergence of the IBR algorithm, we can modify the algorithm based on the concept of e-Nash equilibrium, defined as follows:

Definition 4. A strategy (u*₁, u*₂, . . . , u*_{M}) is an ϵ-Nash equilibrium if and only if ∃ϵ∈ [symbol] ⁺ such that ∀i∈ [symbol] ;

$${C}_{i , t} ( {u}_{i}^{*} , {u}_{- i}^{*} ) \leq {C}_{i , t} ( {u}_{i}^{′} , {u}_{- i}^{*} ) + ϵ , \qquad ( EQ . 20 )$$

$$∀ \text{?} ∈ {𝒰}_{i}^{H} .$$

$$\text{?} \text{indicates text missing or illegible when filed}$$

Combining the IBR approach for the multi-robot navigation game and the human-robot interaction game, we derive Algorithm 2 for solving the distributed MPC problem. It starts with an initial guess [symbol] of the best-response trajectories for the robots. At each iteration j, the coordinator predicts [symbol] , i.e., the trajectories over the next control horizon of human pedestrians by the Social-LSTM model (EQ. 1) where the inputs utilize the robots' trajectories from the previous iteration. The coordinator transmits [symbol] to all the robots. Next, each robot solves its local MPC problem given other robots' best-response trajectories in parallel and decides to accept or reject the new solution based on whether or not it can improve the cost function by at least ϵ. Then, each robot i transmits the current best-response trajectories xᵢ^{(j)} to the coordinator and receives x₋ᵢ^{(j)}. The algorithm is terminated if the coordinator detects that the condition C_{i,t}(uᵢ^{(j)}, u₋ᵢ^{(j)})≤C_{i,t}(uᵢ^{(j-1)}, u₋ᵢ^{(j)})+ϵ is true ∀i∈ [symbol] , or if j=jₘₐₓ.

### Simulation Results

### A. Simulation Setup

Simulated crowd navigation experiments were conducted in Python with the CrowdNav environment, where human pedestrians are simulated using ORCA. Trajnet++ benchmark was used for training Social-LSTM models on the ETH dataset. CasADi and IPOPT solver were used for formulating and solving the nonlinear MPC problems, respectively. The framework parameters were chosen as given in Table III. The simulations were executed on an MSI computer with an Intel Core i9 CPU, 64 GB RAM, and a Geforce RTX 3080 Ti GPU.

### B. Results and Discussions

In some simulations, due to the flocking objective, the robots move from their origins to form a flock with other robots. The flock of robots can navigate among the humans without any collisions. The robots depart from the flock when they are close to their goals, and all the robots eventually reach their goals (e.g., within 16.4 seconds(s), for a simulation with 3 robots and 7 pedestrians in a circular crossing simulation).

To further assess the effectiveness of the proposed framework, performance was analyzed on the following metrics:

Success rate: % of simulations in which all agents reach their destinations.

Average travel time: Time(s) for all robots to reach their destinations (in simulations with success).

Collision rate: % of simulations that the minimum distance between the robots and the pedestrians is less than 0.8 meters (m) (violation of personal space).

Discomfort rate: % of simulations wherein a robot's projected path intersects with a human's projected path. The projected path is defined as a line segment from the current agent's position along with the direction of the agent's velocity and the length proportional to speed.

The proportional factor is chosen as 1.2 s.

The success rate and average travel time quantify the efficiency, while the collision rate and discomfort rate are related to social conformity of the navigation algorithms. Those validation metrics are computed by averaging 1,000 simulations with randomized initial conditions, including 500 circular crossing simulations and 500 perpendicular crossing simulations, with different origins and destinations of the human pedestrians. The metrics for centralized MPC and distributed MPC are compared in Table I, with different numbers of human pedestrians. It can be observed that the performance deteriorates as the crowd density increases. The centralized and distributed MPC algorithms perform similarly, with the centralized approach taking a narrow lead across most metrics.

Furthermore, the benefits of flocking control in reducing personal space violations and discomfort to humans were evaluated. The results for CMPC with and without the flocking control objective are tallied in Table II. The collision and discomfort rates can be reduced by including the flocking objective. Still, the robots generally take longer to reach their goals and decrease the number of successful simulations. The results indicate that moving in a flock can indirectly improve social conformity, but there is a higher chance of “freezing robots” when the flock of robots cannot find a safe yet efficient trajectory to avoid deadlock. This suggests a high-level reference trajectory generator can be combined with the proposed framework to avoid such situations.

TABLE I
Comparison between centralized MPC (CMPC) and distributed MPC (DMPC)

| # of | 5 | | 6 | | 7 | | 8 | | 9 | |
|---|---|---|---|---|---|---|---|---|---|---|
| Pedestrians | Methods | | | | | | | | | |
| Metrics | CMPC | DMPC | CMPC | DMPC | CMPC | DMPC | CMPC | DMPC | CMPC | DMPC |
| Success rate (%) | 94.0 | 93.4 | 91.9 | 91.8 | 90.0 | 88.7 | 86.7 | 86.9 | 84.5 | 83.9 |
| Avg travel time (s) | 17.9 | 18.1 | 18.6 | 18.7 | 19.1 | 19.2 | 19.6 | 19.8 | 20.1 | 20.3 |
| Collision rate (%) | 0.2 | 0.3 | 0.8 | 0.6 | 1.3 | 1.1 | 1.1 | 1.1 | 1.2 | 1.9 |
| Discomfort rate (%) | 0.5 | 0.6 | 1.2 | 1.5 | 1.3 | 1.1 | 1.4 | 1.3 | 2.1 | 1.8 |

TABLE II
Comparison between centralized MPC with flocking objective (F) and
without flocking objective (NF)

| # of | 5 | | 6 | | 7 | | 8 | | 9 | |
|---|---|---|---|---|---|---|---|---|---|---|
| Pedestrians | Methods | | | | | | | | | |
| Metrics | F | NF | F | NF | F | NF | F | NF | F | NF |
| Success rate (%) | 94.0 | 96.7 | 91.9 | 94.0 | 90.0 | 93.8 | 86.6 | 88.8 | 84.7 | 86.1 |
| Avg travel time (s) | 17.9 | 17.6 | 18.6 | 18.4 | 19.1 | 18.8 | 19.6 | 19.3 | 20.1 | 19.8 |
| Collision rate (%) | 0.2 | 0.2 | 0.8 | 0.9 | 1.3 | 0.4 | 1.1 | 1.8 | 1.2 | 2.4 |
| Discomfort rate (%) | 0.5 | 1.4 | 1.2 | 2.2 | 1.3 | 2.0 | 1.4 | 2.2 | 2.1 | 2.6 |

TABLE III
Parameters of the MPC Problem

| Parameters | Values | Parameters | Values |
|---|---|---|---|
| H | 4 | L | 8 |
| τ | 0.4 s | ωᵢ^{goal} | 10.0 |
| ωᵢ^{acce} | 10⁻¹ | ωᵢ^{jerk} | 10⁻¹ |
| ωᵢ^{coll} | 10⁷ | ωᵢ^{floc} | 10 |
| vₘₐₓ | 1.0 m/s | aₘₐₓ | 2.0 m/s² |
| ρ | 0.5 s | dₘᵢₙ | 0.8 m |
| μ | 30 | jₘₐₓ | 10 |
| ξ | 10⁻³ | ϵ | 10⁻³ |

Embodiments of the multi-robot navigation control systems and methods described herein facilitate improving resulting robot movement through an environment containing humans and robots. Specifically, these methods significantly reduce robot “freeze” and jerky motions, and enable the weighting of various objectives depending on the application, such as fastest time, minimized collisions or interactions with humans, and the like. It has been established that applying these game-theoretic methods may improve the navigation and related motion of mobile robots relative to other methods.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A computer-implemented method for controlling navigation of a plurality of mobile robots, the method comprising:
defining a potential game for the plurality of robots with input including a predicted trajectory of each of a plurality of humans in an environment in which the plurality of robots are configured to move and output including a potential function;
iteratively executing processing of a two-player game algorithm until a pre-defined condition is satisfied, wherein, in the two-player game algorithm, the plurality of humans collectively represent a first player having a first cost function associated with the summed predicted trajectories of the plurality of humans, and the plurality of mobile robots collectively represent a second player having a second cost function including the potential function of the potential game;
in response to the pre-defined condition being satisfied, generating control instructions for each robot of the plurality of robots based on output from the two-player game algorithm after a last iteration; and
controlling each of the plurality of robots to move in accordance with the respective control instructions.

2. The computer-implemented method of claim 1, wherein said controlling comprises transmitting the control instructions, respectively, to each of the plurality of robots, the control instructions including computer-executable commands causing each robot to process and execute the respective commands.

3. The computer-implemented method of claim 1, wherein said generating control instructions comprises generating control instructions defining a best-response trajectory for each respective robot.

4. The computer-implemented method of claim 3, further comprising:
in the last iteration, computing a proposed trajectory of each of the plurality of mobile robots; and
accepting the proposed trajectory as the best-response trajectory to be executed by each of the plurality of mobile robots.

5. The computer-implemented method of claim 1, wherein said executing processing of the two-player game algorithm comprises:
optimizing a centralized MPC function for each of the plurality of robots to obtain a proposed trajectory for each of the plurality of robots; and
evaluating the potential function using the proposed trajectory for each of the plurality of robots and the predicted trajectories of the plurality of humans.

6. The computer-implemented method of claim 1, wherein the pre-defined condition is satisfied when a difference in the output from the two-player game algorithm between a previous iteration and the last iteration is less than a threshold value.

7. The computer-implemented method of claim 1, wherein the pre-defined condition is satisfied when the last iteration corresponds to a maximum number of iterations.

8. The computer-implemented method of claim 1, further comprising computing the predicted trajectory of each of the plurality of humans by executing a social long-short term memory (LSTM) model.

9. A computer-implemented method for controlling navigation of a plurality of mobile robots, the method comprising:
iteratively executing processing, by a controller, of a two-player game algorithm until a pre-defined condition is satisfied, comprising:
transmitting, by the controller, to each of the plurality of robots, a predicted trajectory of each of a plurality of humans in an environment in which the plurality of mobile robots are configured to move;
receiving, from each of the plurality of robots, a respective current best-response trajectory that is current to the respective iteration;
transmitting, to each of the plurality of robots, the received current best-response trajectories of each other robot of the plurality of robots; and
receiving, from each of the plurality of robots, a convergence signal in response to said transmitting;
in response to the pre-defined condition being satisfied, generating, by the controller, control instructions for each robot of the plurality of robots based on output from the two-player game algorithm after a last iteration; and
controlling each of the plurality of robots to move in accordance with the respective control instructions.

10. The computer-implemented method of claim 9, wherein said controlling comprises transmitting, by the controller, the control instructions, respectively, to each robot of the plurality of robots, the control instructions including computer-executable commands causing each robot to process and execute the respective commands.

11. The computer-implemented method of claim 9, wherein said generating control instructions comprises generating, by the controller, control instructions defining an actual best-response trajectory for each respective robot.

12. The computer-implemented method of claim 11, further comprising:
in the last iteration, receiving, by the controller, a positive convergence signal from each of the plurality of mobile robots; and
accepting the current best-response trajectories of the plurality of robots as the actual best-response trajectories.

13. The computer-implemented method of claim 9, wherein said executing processing of the two-player game algorithm further comprises:
solving, by each robot of the plurality of robots in parallel, a local MPC function to obtain the current best-response trajectory that is current to the respective iteration.

14. The computer-implemented method of claim 9, wherein said executing processing of the two-player game algorithm further comprises:
in response to receiving the current best-response trajectories of each other robot of the plurality of robots, solving, by each robot, a local MPC function to determine whether the current best-response trajectories of the plurality of robots improves an outcome relative to previously computed best-response trajectories of the plurality of robots.

15. The computer-implemented method of claim 14, further comprising:
when said solving indicates an improved outcome, transmitting, by each of the plurality of robots, the convergence signal including a positive convergence signal to the controller.

16. The computer-implemented method of claim 9, wherein the pre-defined condition is satisfied when the convergence signal includes a positive convergence signal.

17. The computer-implemented method of claim 9, wherein the pre-defined condition is satisfied when the last iteration corresponds to a maximum number of iterations.

18. The computer-implemented method of claim 9, further comprising computing the predicted trajectory of each of the plurality of humans by executing a social long-short term memory (LSTM) model.

19. A control system comprising:
a plurality of mobile robots; and
a controller comprising at least one processor and at least one memory, the controller communicatively coupled to the plurality of robots and programmed to execute the computer-implemented method of claim 1.

20. A control system comprising:
a plurality of mobile robots; and
a controller comprising at least one processor and at least one memory, the controller communicatively coupled to the plurality of robots, the controller programmed to execute the computer-implemented method of claim 9.
